(19) United States
(12) Patent Application Publication
(10) Pub. No.: US 2014/0259704 A1
(43) Pub. Date: Sep. 18, 2014

(54) ACCESSORY FOR A RECIPROCATING SAW

(71) Applicant: TECHTRONIC POWER TOOLS TECHNOLOGY LIMITED, Tortola (VG)

(72) Inventor: Christopher Clearman, Half Moon Bay, CA (US)

(73) Assignee: TECHTRONIC POWER TOOLS TECHNOLOGY LIMITED, Tortola (VG)

(21) Appl. No.: 13/829,857

(22) Filed: Mar. 14, 2013

(51) Int. Cl. B23D 59/00

(52) U.S. Cl. CPC B23D 59/00
USPC 30/514

(57) ABSTRACT

An accessory for a reciprocating power tool includes an elongated post having a base member disposed at a distal end thereof. The base member includes an aperture. The accessory includes first and second members coupled on opposite sides of the base portion. Each of the first and second side members includes a surface having a toothed portion and a non-toothed portion.

### BACKGROUND

The present invention relates to accessories for power tools, and more particularly to an accessory for a reciprocating saw.

Reciprocating tools, such as reciprocating saws, typically include removable blades to allow for replacement of worn or damaged blades. Reciprocating tools also include removable accessories that accommodate a variety of working members. The accessories enable the reciprocating tools to be used for numerous applications on various working surface and for a variety of types of projects

### SUMMARY

In some constructions, the invention provides an accessory for a reciprocating power tool. The accessory includes an elongated post having a base member disposed at a distal end thereof. The base member includes an aperture. First and second side members are coupled to the opposite sides of the base member. Each of the first and second side members includes a surface having a toothed portion and a non-toothed portion.

In another construction, the invention provides reciprocating power tool including a housing supporting a motor, which is actuatable by a trigger. The power tool also includes a spindle coupled to the motor such that the motor reciprocatingly drives the spindle. The spindle includes a blade clamp mechanism coupled to a distal end thereof. An accessory is coupled to the reciprocating power tool, and includes an elongated post having a base member disposed at a distal end thereof. The base member includes an aperture. First and second side members are coupled to the opposite sides of the base member. Each of the first and second side members includes a surface having a toothed portion and a non-toothed portion.

Other aspects of the invention will become apparent by consideration of the detailed description and accompanying drawings.

### BRIEF DESCRIPTION OF THE DRAWINGS

FIG. 1 is a side view of a reciprocating power tool including a blade clamp for receiving an accessory.

FIG. 2 is a side view of the reciprocating saw shown in FIG. 1, including an accessory according to one embodiment of the invention.

FIG. 3 is a perspective view of the accessory shown in FIG. 2.

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways.

### DETAILED DESCRIPTION

FIG. 1 illustrates a power tool 10 including a housing 14 having a handle portion 16, a motor (not shown) positioned within the housing 14, and a spindle 18 operatively coupled to the motor. A power tool 10 drive mechanism (not shown) positioned substantially within the housing 14 is coupled to the motor for transferring rotational motion of a shaft of the motor into reciprocating motion of the spindle 18 along a longitudinal axis A relative to the housing 14. A blade clamp mechanism 12 is disposed at a distal end of the spindle 18 for receiving a working member (not shown). The blade clamp mechanism 12 secures the working member to the spindle 18 for reciprocation with the spindle 18 in a direction B, which is substantially parallel to the longitudinal axis A. In other embodiments, other suitable types and configurations of blade clamp mechanisms may be employed.

With continued reference to FIG. 1, the power tool 10 includes a trigger-type power switch or trigger 24 for activating a power supply 26 of the tool 10. In the illustrated embodiment, the power supply 26 is a rechargeable battery pack. The battery pack 26 is releasably coupled to the handle portion 16 to provide power to the power tool 10, and is releasable away from and forward of the handle portion 16. In the illustrated embodiment, the battery pack 26 is an eighteen-volt (18V) rechargeable power tool battery pack. In other embodiments, the battery pack 26 may be a twelve-volt (12V), a twenty-four-volt (24V), or other various voltages that are known in the art. According to another embodiment, the power supply 26 may be an alternating current (AC) power provided via a corded plug electrically coupled to a wall outlet or any number of suitable powering options.

In other embodiments, the power tool 10 may include various handle constructions, drive mechanisms, blade clamp mechanisms, and power configurations that are known in the art. In further embodiments, the power tool 10 may include other types of power and speed control switches or may not include a speed control feature.

FIGS. 2-3 illustrate an accessory or shoe 50 according to one embodiment of the invention. The accessory 50 includes an elongate post 54 secured within and extending from the housing 14. The elongate post 54 includes a base member 58 at a distal end. The base member 58 includes an aperture 62 for receiving a working member 66 (i.e., a saw blade) therethrough. First and second side members 70, 74 are coupled to opposite sides of the base member 62. In the illustrated embodiment, the first and second side members 70, 74 are integrally formed with first and second arms 78 (only one of which is shown), respectively, that extend along opposite sides of the saw blade 66.

The first and second side members 70, 74 each include a substantially arcuately-shaped surface 86 extending beyond a plane 88 defined by the base member 58 and having a variable radius of curvature. The surfaces 86 each include a toothed or spiked portion 90 and a non-toothed or smooth portion 94. Teeth 98 and gullets 102 define the toothed portions 90. Each of the teeth 98 has a variable height such that the toothed portion 90 defines an arc 106 having a variable radius of curvature. Similarly, the non-toothed portion 94 also defines an arc 110 having a radius of curvature. The radius of the non-toothed portion 90 is different than the radius of the toothed portion 94. The first and second side members 70, 74 are parallel to one another such that the teeth 98 and gullets 102 of the toothed portions 90 and the non-toothed portions 94 are horizontally aligned.

In operation, the accessory 50 interfaces with a working surface (not shown) in order to assist the blade 66 while performing a cut. The teeth 98 contact the working surface such that the blade 66 is forced pry the material rather than push the material as reciprocation of the spindle 18, upon actuation of the trigger 24, causes the blade 66 to reciprocate within the shoe 50. Additionally, the non-toothed portion 94 allows the blade 66 to drop to the bottom of the cut and therefore, creates room for the teeth 98 to bite the material. As a result, the cut progresses quicker and easier thereby reducing the effort required to cut a material.

In the embodiment illustrated in FIGS. 2 and 3, the teeth 98 are substantially rectangularly-shaped and adjacent teeth are separated by substantially arcuately-shaped gullets 102. Additional embodiments may include teeth and gullets having any suitable size and shape. Further, there may be fewer or more teeth, and therefore fewer or more gullets, than are depicted in the illustrated embodiment. Additionally, while the side members 70, 74, and therefore each of the teeth 98 and gullets 102, are horizontally aligned in the embodiment illustrated in FIGS. 2 and 3, it is contemplated that the side members could be offset from one another such that the teeth of one member may be aligned with the gullets of the opposite member. Further, while the illustrated accessory 50 includes a toothed portion 90 that is larger than the non-toothed portion 94, further embodiments may include toothed portions that are the same size as the non-toothed portions. Additionally, the surface of each of the first and second side members may have arcs with radii of curvature that are larger or smaller than the radii illustrated in FIGS. 2 and 3. Similarly, the radii defined by each of the toothed and non-toothed portions may have other constructions than those illustrated herein. For example, the toothed portion and the non-toothed portion may define a uniform radius of curvature.

Thus, constructions of the invention provide, among other things, an accessory used in conjunction with a power tool and including a toothed portion and a non-toothed portion. The toothed portion forces the blade to a pry, rather than push, material, while the non-toothed portion creates room for the toothed portion to cut by sliding to a bottom of a cut. The accessory, therefore, reduces the effort required to cut a material by allowing the cut to progress quicker and easier.

Various features of the invention are set forth in the following claims.

What is claimed is:

1. An accessory for a reciprocating power tool, the accessory comprising:
an elongated post;
a base member disposed at a distal end of the post, the base member including an aperture;
a first side member coupled to the base member; and
a second side member coupled to the base member, the second side member opposite the first side member;
wherein each of the first and second side members include a surface having a toothed portion and a non-toothed portion.

2. The accessory of claim 1, wherein the surface of each of the first and second side members is substantially arcuately-shaped and has a variable radius of curvature.

3. The accessory of claim 1, wherein the toothed portion includes a plurality of teeth, each adjacent tooth separated by a gullet.

4. The accessory of claim 3, wherein each of the plurality of teeth has a variable height such that the spiked surfaces define an arc having a variable radius of curvature.

5. The accessory of claim 4, wherein the non-toothed portion defines an arc having a radius of curvature that is different than the arc of the toothed portion.

6. The accessory of claim 3, wherein the first and second side members are parallel to one another such that the teeth and gullets of the toothed portion and the non-toothed portion are horizontally aligned.

7. The accessory of claim 1, wherein the toothed portion makes up a larger portion of the surface of each of the first and second side members than the non-toothed portion.

8. The accessory of claim 1, wherein the surface of each of the first and second side members extends beyond a plane defined by the base member.

9. A reciprocating power tool comprising:
a housing supporting a motor, the motor actuatable by a trigger;
a spindle coupled to the motor wherein the motor reciprocatingly drives the spindle, the spindle including a blade clamp mechanism coupled to a distal end thereof;
an accessory member comprising:
an elongated post;
a base member disposed at a distal end of the post, the base member including an aperture;
a first side member coupled to the base member; and
a second side member coupled to the base member, the second side member opposite the first side member;
wherein each of the first and second side members include a surface having a toothed portion and a non-toothed portion.

10. The reciprocating power tool of claim 9, wherein the surface of each of the first and second side members is substantially arcuately-shaped and has a variable radius of curvature.

11. The reciprocating power tool of claim 9, wherein the toothed portion includes a plurality of teeth, each adjacent tooth separated by a gullet.

12. The reciprocating power tool of claim 11, wherein each of the plurality of teeth has a variable height such that the spiked surfaces define an arc having a variable radius of curvature.

13. The reciprocating power tool of claim 12, wherein the non-toothed portion defines an arc having a radius of curvature that is different than the arc of the toothed portion.

14. The reciprocating power tool of claim 11, wherein the first and second side members are parallel to one another such that the teeth and gullets of the toothed portion and the non-toothed portion are horizontally aligned.

15. The accessory of claim 9, wherein the toothed portion makes up a larger portion of the surface of each of the first and second side members than the non-toothed portion.

16. The reciprocating power tool of claim 9, wherein the surface of each of the first and second side members extends beyond a plane defined by the base member.

17. The reciprocating power tool of claim 9 further comprising a working member received by the blade clamp mechanism.

18. The reciprocating power tool of claim 17 wherein the working member extends through the aperture in the base member.

19. The reciprocating power tool of claim 9, wherein the post is received within the housing to secure the accessory to the power tool.
